(19) United States
(12) Patent Application Publication
(10) Pub. No.: US 2005/0165888 A1
(43) Pub. Date: Jul. 28, 2005

(54) Peer-to-peer data binding

(75) Inventor: Geoffrey Elliott, Seattle, WA (US)

Correspondence Address: LEYDIG, VOIT & MAYER, LTD., TWO PRUDENTIAL PLAZA, SUITE 4900, 180 NORTH STETSON, CHICAGO, IL, 60601-6780, US

(73) Assignee: Microsoft Corporation, Redmond, WA (US)

(21) Appl. No.: 10/765,534

(22) Filed: Jan. 27, 2004

(51) Int. Cl. G06F 15/16

(52) U.S. Cl. 709/203; 709/207

(57) ABSTRACT

A technique for data replication and propagation allows synchronization of user interfaces on peer machines in a peer-to-peer network. Data binding synchronizes data sources and corresponding UI objects. Further, in an embodiment of the invention, object persistence is utilized to transform changed data source objects to a data stream for propagation via a peer graph record structure. A standard interface such PersistSave is then used in an embodiment of the invention to create and load the propagated object on a peer machine.

### FIELD OF THE INVENTION

This invention relates generally to peer-to-peer networks and, more particularly, relates to a system and method for synchronizing user interface elements on peer machines in a peer-to-peer network.

### BACKGROUND

As computers become more central to everyday life, users seek to be able to do more and more with their computer. Most tasks that can be done from a computer require or at least benefit from network connectivity. For example, paying one's bills online requires that the user's computer is connected to a network so that the payment information can be sent to the appropriate recipient. In addition, email, online shopping, desktop teleconferencing, etc. all require some degree of network connectivity.

There are a number of different network types, but one prevalent form of network is the peer-to-peer network. A peer-to-peer network is one in which peer machines are networked together and maintain the state of the network via records on the participant machines. In peer-to-peer networks, each end node has broadly the same capabilities, and any node can initiate communications. Peer-to-peer networks are also sometimes referred to as “endhost” networks. Typical peer-to-peer networks lack a central server for administration, although hybrid networks do exist. So, generally speaking, the term peer-to-peer refers to a set of technologies that allows a group of computers to directly exchange data and/or services. The distinction between peer-to-peer networks and other network technologies is really more about how the member computers communicate with one another than about the network structure itself. For example, many peer-to-peer networks utilize the Internet for communications, but the Internet can also be used for other types of networking.

An increasingly popular use of peer-to-peer networks is for online group interaction. One example of an online group interaction application is given in copending U.S. patent application Ser. No. 10/230,247, entitled System And Method For Shared Integrated Online Social Interaction, filed Aug. 28, 2002, which is herein incorporated by reference in its entirety for all that it teaches without exclusion. Typically, a user accesses the group interaction application via a desktop icon or otherwise on their computer. Through the application, the user has immediate interactive access to a group of online friends. Group members may engage in a number of shared activities including photograph sharing and viewing, and shared listening of audio material, such as a recitation or recording of interest. In addition, shared chatting, browsing, planning, scheduling, and so on are also desirable to some users. Many other shared activities are possible as well, and although the present description will focus primarily on certain activities, it will be understood that the disclosed principles are applicable to other types of activities, including but not limited to those described in the copending application identified above.

During a shared activity, the group interaction application ensures that each online member sees the same representation of the shared activity as additions, deletions, and modifications are made. One mechanism for synchronizing the presentation of each member is a peer-to-peer network as described above, although other connection mechanisms, including those with centralized switching or storage, are also usable. However, existing synchronization techniques are complicated to program to and increase the overhead required for networking. There is a need for an improved and simplified mechanism for synchronizing user interface elements over a peer-to-peer network.

### BRIEF SUMMARY OF THE INVENTION

The present description discloses a technique for synchronizing user interfaces on peer machines in a peer-to-peer network. In particular, data binding is used to ensure that data sources and corresponding UI objects remain mutually synchronized. Further, in an embodiment of the invention, object persistence is utilized to transform changed data source objects to a data stream for propagation via a peer graph record structure. Furthermore, in an embodiment of the invention, a standard interface is then used to create and load the propagated object on a peer machine. Thus the invention is directed in embodiments to an N to N replicated data store and presentation.

Additional features and advantages of the invention will be made apparent from the following detailed description of illustrative embodiments which proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram generally illustrating an example device architecture in which all or a part of embodiments of the present invention may be implemented;

FIG. 2A is a network diagram of an architecture for implementing an embodiment of the invention;

FIG. 2B is a schematic network diagram showing sample logical relations among peer machines usable to implement an embodiment of the invention;

FIG. 3 is an architecture diagram of a group interaction environment usable to implement an embodiment of the invention;

FIG. 4 is schematic diagram illustrating two peer machines in a peer-to-peer network and associated components within each according to an embodiment of the invention;

FIG. 5 is an object interface level schematic according to an embodiment of the invention; and

FIG. 6 is a flow chart illustrating steps according to an embodiment of the invention for maintaining synchronized user interfaces over a peer-to-peer network.

### DETAILED DESCRIPTION

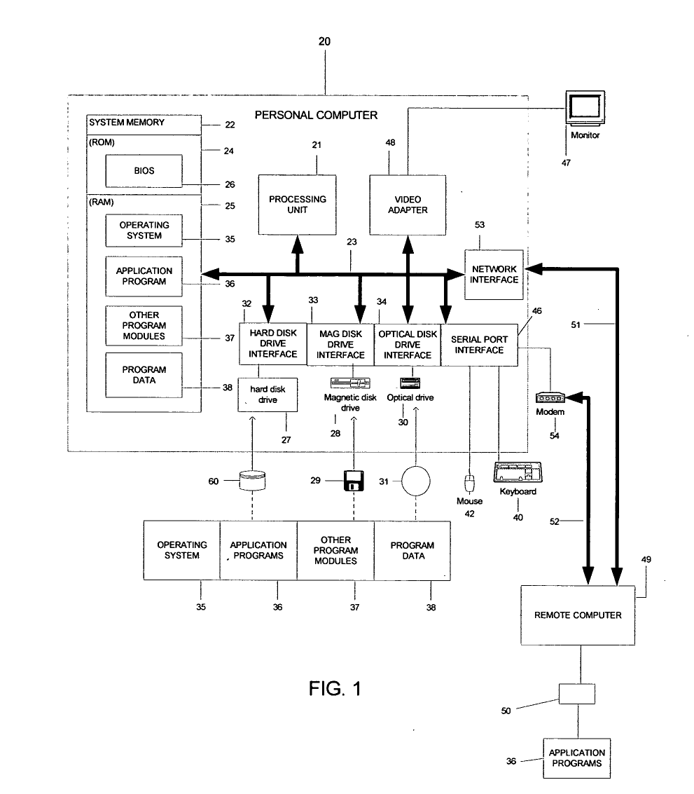

The invention pertains to online group interaction over a computer network and to a novel system and method for synchronizing user interface elements over a network. The invention thus operates in a computer environment. In an embodiment of the invention, the described process operates on a collection of one or more computing devices. A suitable computing device usable in implementing all or some aspects of the invention will be first described with reference to FIG. 1, after which a network environment according to particular embodiments of the invention will be more fully described.

Although there are many computing devices suitable for implementing the invention, several exemplary types of computing devices are discussed below with respect to FIG. 1. It will be appreciated that this explanation is given for ease of understanding and is not intended to limit the scope of the invention.

Although not required, the invention will be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may be practiced in distributed computing environments where tasks are performed by remote processing devices that are linked through a communications network. In a distributed computing environment, program modules may be located in both local and remote memory storage devices.

Turning now to FIG. 1, a general purpose computing device is shown in the form of a conventional computer 20, including a processing unit 21, a system memory 22, and a system bus 23 that couples various system components including the system memory to the processing unit 21. The system bus 23 comprises one or more physical busses of any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk 60, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for the computer 20. Although the exemplary environment described herein employs a hard disk 60, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, storage area networks, and the like may also be used in the exemplary operating environment. A number of program modules may be stored on the hard disk 60, magnetic disk 29, optical disk 31, ROM 24 or RAM 25, including an operating system 35, one or more applications programs 36, other program modules 37, and program data 38.

A user may enter commands and information into the computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB) or a network interface card. A monitor 47 or other type of display device is also connected to the system bus 23 via an interface, such as a video adapter 48. In addition to the monitor, computers may include other peripheral output devices, not shown, such as speakers and printers.

The computer 20 operates in a networked environment using logical connections to one or more remote computers, such as a remote computer 49. The remote computer 49 may be a domain controller, server, a router, a network PC, a personal computer, a peer device or other common network node, and typically includes many or all of the elements described above relative to the computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the computer 20 is connected to the local network 51 through a network interface or adapter 53. When used in a WAN networking environment, the computer 20 typically includes a modem 54 or other means for establishing communications over the WAN 52. The modem 54, which may be internal or external, is connected to the system bus 23 via the serial port interface 46. Program modules depicted relative to the computer 20, or portions thereof, may be stored in the remote memory storage device if such is present. It will be appreciated that the network connections shown are exemplary and other means of establishing a communications link between the computers may be used.

Herein, the invention will generally be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operations described hereinafter may also be implemented in hardware. In the following discussion, computing devices such as clients, domain controllers, servers, and so on may be of the architecture as described above with respect to FIG. 1 regarding computer 20 and/or remote computer 49, or may alternatively have any other type of architecture. The computer operations described herein are executed pursuant to the reading of computer-executable instructions from a computer-readable medium by a computer or computing device. Computer-readable media include optical, magnetic, electrical and other types of media, as well as storage media, transmission media, and so on.

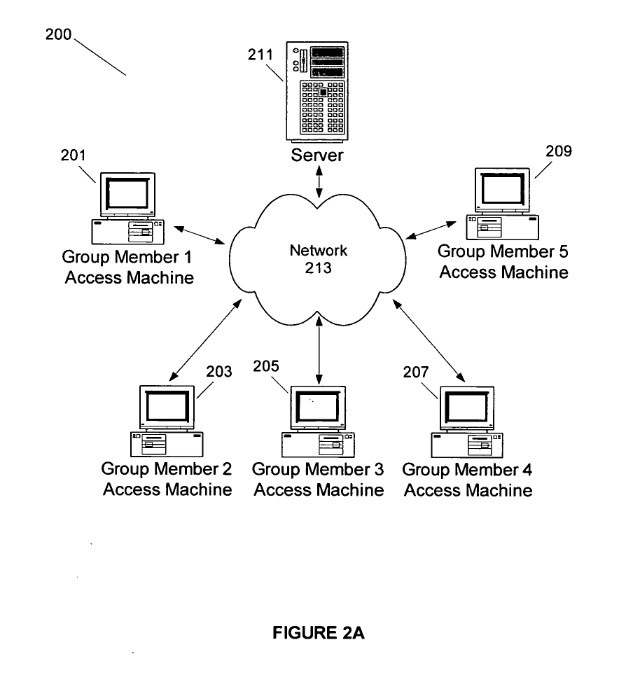

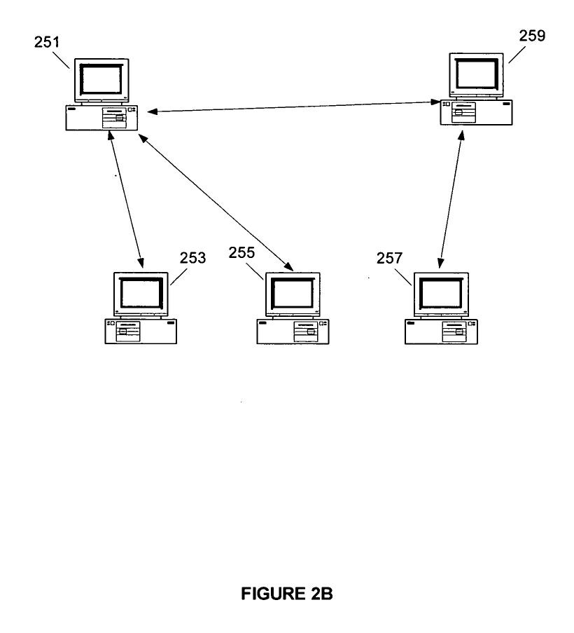

FIG. 2A illustrates in schematic form a network architecture for implementing particular embodiments of the invention, although other embodiments of the invention are not excluded. A number of user computers are identified as Group Member 1 Access Machine (201), Group Member 2 Access Machine (203), Group Member 3 Access Machine (205), Group Member 4 Access Machine (207), and Group Member 5 Access Machine (209). The user computers 201, 203, 205, 207, 209 are illustrated as connected or connectable to each other via network 213.

The computers 201, 203, 205, 207, 209 are used by individual users to interact with other individual users of other ones of the computers 201, 203, 205, 207, 209. Typically, each computer 201, 203, 205, 207, 209 will have running thereon a group interaction application usable to display a representation of a group interaction space, as will be discussed in greater detail below, and to update that representation or the representations on other user machines via the network 213. The group interaction application also exposes ways in which the user can interact with the rest of the online group, such as by adding or modifying content, annotating content, communicating with other members, etc.

In addition to the aforementioned components, a server computer 211 is connected or connectable to network 213 in an embodiment of the invention, although it is excluded in an alternative embodiment of the invention. One purpose of the sever computer 211, when used, is to store the state of the group, e.g., networking data, membership data, etc., and/or to store group data, e.g., shared content, projects, etc. In the alternative embodiment of the invention wherein the server 211 is not used, the network 213 is a pee-to-peer network, with the state of the group and the group data being stored on the member machines 201, 203, 205, 207, 209. Note that although five machines and one server are illustrated, this configuration is simply an example, and any number of machines and/or servers, when used, may be included. Furthermore, although the network is illustrated in a manner often associated with large switched networks, any type of networking technology may be used. Furthermore, in a peer-to-peer network, certain computers may only be able to access other computers by going through an intermediary, which may or may not be one of the group member access machines.

FIG. 2B shows the potential logical relations among the machines of FIG. 2A, according to a peer tree graph 250. It will be understood that any other possible peer tree structure may be used, and that indeed in certain embodiments of the invention it is contemplated that multiple such trees are used. In the illustrated example, it can be seen that machines 251, 253, 255, 257, and 259, corresponding to machines 201, 203, 205, 207, and 209 respectively, are interconnected logically with machine 251 linked to machines 253 and 255, machine 253 linked to machine 251, machine 255 linked to machine 251, machine 257 linked to machine 259, and machine 259 linked to machines 251 and 257.

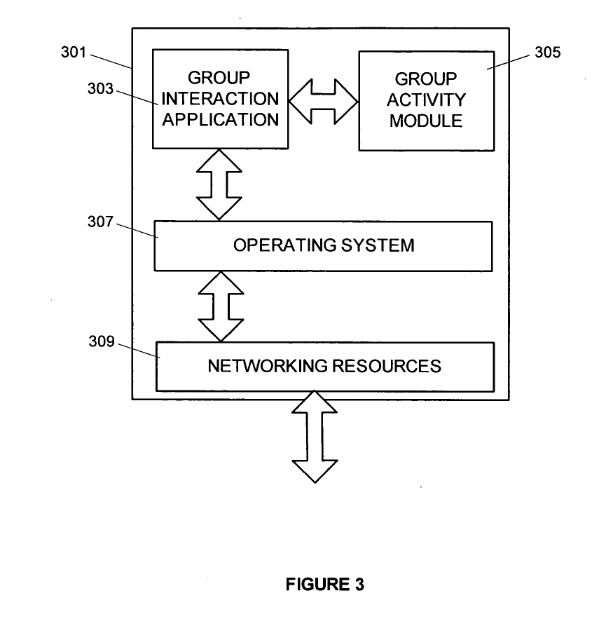

Referring to FIG. 3, the group interaction application 303 resides in active computer memory 301 with a group activity module 305, an operating system 307, and networking resources 309 for the computer. The group interaction application 303 interacts with the group activity module 305 to determine what content to display at any given moment to the user of the particular computer. In addition, the group interaction application 303 uses the networking resources 309 via the operating system 307 to communicate with other user machines, such as for sharing data, including text, pictures, videos, photographs, audio, etc., and synchronizing the user views. The computer-executed steps below are executed in an embodiment of the invention by one or both of the group interaction application 303 and the group activity module 305.

In an embodiment of the invention, data binding is used in conjunction with a peer graph associated with a suitable peer-to-peer technology such as “Windows Peer-to-Peer Networking” technology, herein referred to generally as “peernet,” to synchronize user interface elements of group members connected over a peer-to-peer network. It will be appreciated by those of skill in the art that the Peer-to-Peer Graphing and Peer-to-Peer Grouping Infrastructures are usable to implement the peer-to-peer aspects herein. An N to N object store is created by combining object persistence with a peer model. Prior to discussing the invention in greater detail, the concept of data binding will be briefly discussed for the convenience of the reader. Data binding is technique for tying objects or other entities to data. For example, a user may fill in a form on their computer in conjunction with a server located over a network connection. The form may have boxes or fields for various types of data, such as name, address, and so on. The data for the relevant fields can reside on the server, with each data field UI object or entity on the client being bound or tied to the appropriate data. Thus, for example, when the form loads at the client, the data for filling the various fields is automatically retrieved in its most updated form from the server because of the data binding.

The concept of data binding is used herein to synchronize user interfaces of multiple machines across a peer-to-peer network. For example, during an online music listening activity, if one member adds a song to the playlist, that change should be quickly reflected in the user interfaces of the other group members. Similarly, during an online group photo sharing activity, when a photograph is added, removed, annotated, etc., that change should be quickly propagated. In this way, the group members have a sense of a real-time shared experience. Various examples of user interfaces are shown in U.S. patent application Ser. No. 10/230,247, discussed above and incorporated by reference, however the invention herein may be used with any type of user interface.

One suitable technology for sharing data within a peer-to-peer network is technology of peernet. Peernet uses data structures called records to transfer information throughout the peer-to-peer network. A record is typically data with accompanying metadata such as create time, expire time, type, size, etc. Thus, using peernet, if a song is added to a local user interface by a user, then in order for that change to propagate, the change must be recognized and the song, and data related to the song, must be transformed into pure data that can be sent via one or more records.

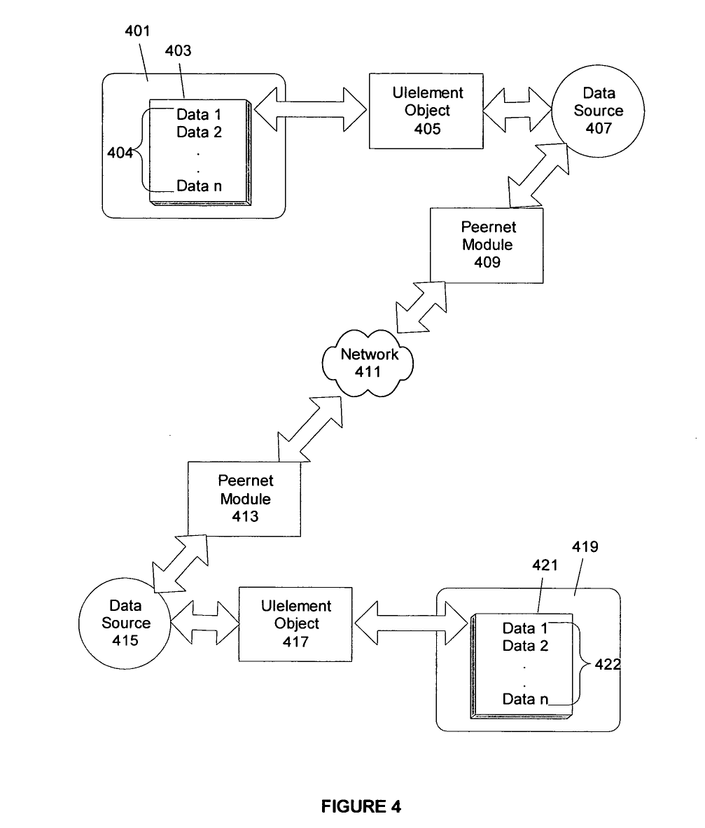

The principles according to an embodiment of the invention will be described by reference to the schematic diagram of FIG. 4. FIG. 4 shows a simplified user interface 401, containing a user interface element 403. For the sake of example, the user interface element 403 is shown as containing (displaying) data 404 including data elements l through n.

The user interface element 403 is generated based on a UIelement object 405. Although not shown in the simplified illustration of FIG. 4, it will be appreciated by those of skill in the art that the UIelement object 405 may itself be based on or linked to one or more other objects. For example, the UIelement object 405 may represent a song playlist and may incorporate other objects that represent individual songs. The object UIelement 405 is linked to a data source object 407, such as an actual copy of a playlist, document, photograph, song, etc. The data source 407 is in turn linked to a peernet module 409 which is linked over a network 411 to a counterpart module 413 associated with another peer machine.

The peer machine has similar components 413, 415, 417, 419, 421, and 422 corresponding to components 401, 403, 404, 405, 407, and 409 respectively. In operation each peernet module 409, 413 communicates with the other by sending and receiving records over the network 411. Each peernet module 409, 411 is also responsible for exchanging data with the respective UIelement object 405, 417. Thus, it can be seen that the exchange between the UIelement object 405, 417 and the respective data sources 407, 415 is in terms of objects whereas the exchange between the data sources 407, 415 and the respective peernet modules 409, 413 is in terms of data.

Peernet can be used to ensure that the data sources 407, 415 are synchronized, i.e., that a change to a data source on any peer machine is reflected to all other peer machines. However, this does not ensure that the respective user interfaces such as interfaces 401, 419 will be automatically synchronized. Accordingly, a data binding technique is used in embodiments of the invention to maintain synchronous user interfaces over the peer-to-peer network.

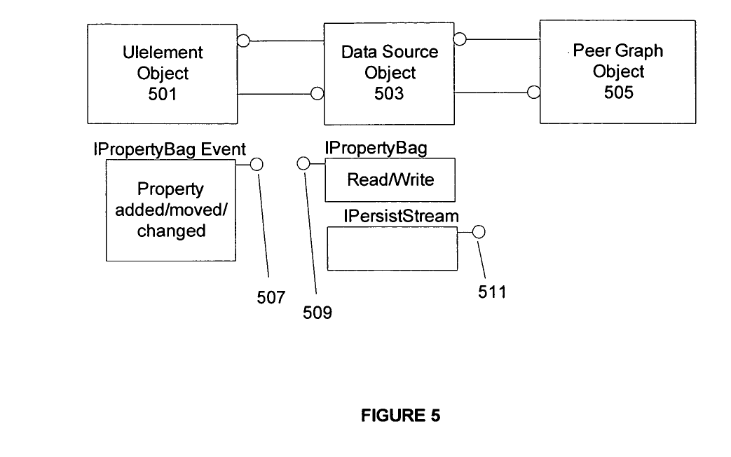

An exemplary manner in which data binding is used according to an embodiment of the invention will be described in greater detail with reference to FIG. 5, which shows an object interface level schematic view of several objects in the data path. In particular, the UIelement object 501 exposes interfaces to and accesses interfaces of, the data source object 503. Further, the data source object 503 exposes a property interface such as an IProperty interface 509 to the UIelement object 501. The UIelement object 501 is able to read from or write to this interface. By specifying a property to the interface 509, the UIelement object 501 is able to subscribe to notification of changes to that property. In keeping with this functionality, the UIelement object 501 exposes an IPropertyBag Event interface 507 usable by the data source object 503 to notify the UIelement object 501 of changes regarding the subscribed property.

Thus, for example, the UIelement object 501 may use the IPropertyBag interface to subscribe to changes in an “active” property of a song in the playlist, wherein the active property conveys which song is currently playing. When the property changes, i.e. goes from active to nonactive or vice versa, the data source object 503 notifies the UIelement object 501 the of change via the IPropertyBag Event interface or the like. This foregoing set of functions are referred to herein as data binding. As a result, the UI aspects that are derived from the UIelement object 501 also change. In this manner, any change in the user interface of any group member is propagated over the peer-to-peer network.

In practice, the number of bound objects and the complexity are often higher. For example, label and picture objects may be bound to a song object while a list object may be bound to a song collection containing the song object. Objects may thus comprise other objects with different binding than the enclosing object.

In order to propagate objects over the peer-to-peer network using peernet or other record exchange service, the objects should be in data form rather than object form. In order to facilitate this in an embodiment of the invention, each data source object such as object 503 also exposes an interface IPersistStream 511, which can be used by the peer graph object 505 to access a data stream corresponding to the object. In particular, the interface 511 can be queried to determine whether the object in question can persist or save itself to a stream. If so, a method such as PersistSave can be used to create the stream. The peer graph object 505 utilizes this interface to retrieve data corresponding to the object to be stored in a data record for propagation over the peer-to-peer network. At the recipient machine, the data stream can be reconstructed into a copy of the propagated object by using a method such as PersistCopy given a parameter of (stream). Thus, methods such as PersistSave and PersistCopy can be used to put data into and extract data from peernet or other data records.

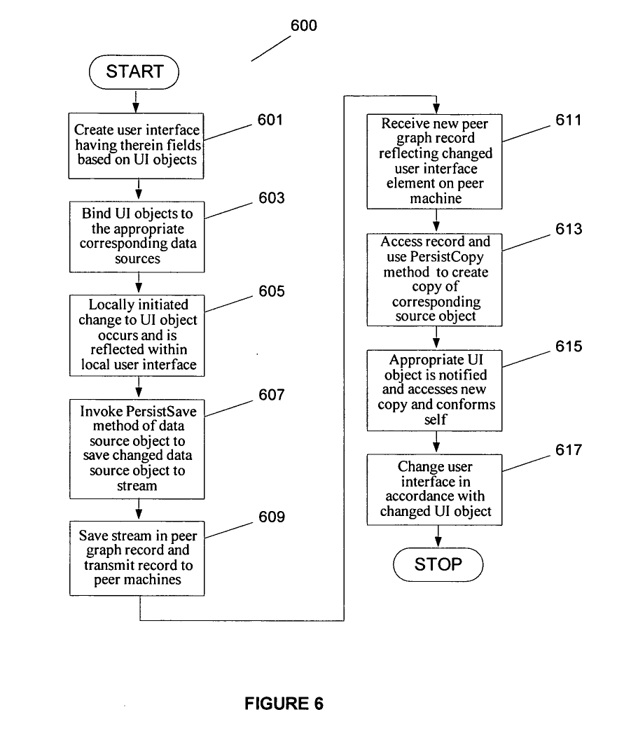

FIG. 6 illustrates in flow chart form 600 a process of establishing a user interface, propagating changes to that user interface, and applying changes propagated from user interfaces of other peer machines. At step 601, a user interface is created, for example from an XML file, having therein fields based on UI objects. During creation, data for one or more fields of the interface is obtained by the appropriate UI objects from one or more corresponding data source objects identified in the XML file. At step 603, which may occur simultaneously or generally contemporaneously with step 601, the UI objects are bound to the appropriate data sources as described above so that changes within the user interface can be propagated and so that changes to the user interfaces of peer machines can be replicated locally.

At step 605, a locally initiated change to a UI object occurs and is reflected within the user interface. In addition, the change is sent to the appropriate data source object. At step 607, the PersistSave method of the data source object is used to save the changed data source object to a stream. At step 609, the stream is saved in a peer graph record and transmitted to the peer machines.

The local machine receives a new peer graph record at step 611 reflecting a changed user interface element on a peer machine. At step 613, the record is accessed and the PersistCopy method is used to create a copy of the corresponding source object from the data of the record. The data source object is one to which a UI object is bound, and thus at step 615 the appropriate UI object is notified of the change and accesses the new copy of the object and conforms itself accordingly to reflect the changes. Finally, at step 617 the user interface is changed in accordance with the changed UI object.

It will be appreciated that an improved system and method for synchronizing user interface elements during an online group interaction have been described. In view of the many possible embodiments to which the principles of this invention may be applied, it should be recognized that the embodiments described herein with respect to the drawing figures are meant to be illustrative only and should not be taken as limiting the scope of invention. For example, those of skill in the art will recognize that some elements of the illustrated embodiments shown in software may be implemented in hardware and vice versa or that the illustrated embodiments can be modified in arrangement and detail without departing from the spirit of the invention. In addition, the illustrated user interface elements may be modified in arrangement, appearance, content, extent etc. within the invention. Therefore, the invention as described herein contemplates all such embodiments as may come within the scope of the following claims and equivalents thereof.

1. A method of synchronizing user interfaces on a plurality of peer machines within a peer-to-peer network comprising:
binding a display object on a first of the plurality of machines to a data source object on the first machine, the display object corresponding to a user interface element, the data source object comprising data usable by the display object for constructing the user interface element;
notifying the display object from the data source object that a change in the data source object has occurred, the change in the data source object being in accordance with a change in the user interface of a second of the plurality of peer machines within the peer-to-peer network;
retrieving information representative of the changed data source object by the display object from the data source object; and
conforming the user interface element to reflect the changed data source object.

2. The method according to claim 1, further comprising:
receiving over the network from the second of the plurality of machines a record having therein data, wherein the data is representative of a user interface element displayed on the second machine; and
creating the change in the data source object by extracting the data from the received record.

3. The method according to claim 2, wherein extracting the data from the received record comprises employing a model of object persistence to create an object from the data of the received record.

4. The method according to claim 1, wherein binding the display object on the first machine to the data source object comprises subscribing by the display object to notification of a change in one or more properties of the data source object.

5. The method according to claim 4, further comprising providing a notification interface by the display object to receive notification of a change in one or more properties of the data source object, and wherein notifying the display object from the data source object that a change in the data source object has occurred comprises calling of the notification interface by the data source object.

6. The method according to claim 1, wherein users of the plurality of machines are engaged in a group interaction session over the network, wherein each machine manifests a media item to the respective user.

7. The method according to claim 6, wherein the change to the data source object represents a change with respect to the media item.

8. An apparatus for creating a replicated user interface on each of a plurality of networked computers comprising:
a display on each of the plurality of networked computers;
a display object for causing a user interface element to be displayed on each of the plurality of networked computers;
on each of the plurality of networked computers a data source object bound to the display object, wherein any change to the data source object is reflected in the display object via the binding; and
a peer graph object on each of the plurality of networked computers for receiving data from any one of the others of the plurality of networked computers, and forwarding such data to the data source object.

9. The apparatus according to claim 8, wherein the display object is further operable for implementing a local change to the data source object pursuant to a change in the user interface of the respective computer, and wherein the peer graph object is further operable to retrieve data corresponding to the local change and forward the data corresponding to the local change to all others of the plurality of networked computers.

10. A computer-readable medium having thereon computer-executable instructions for performing a method of synchronizing user interfaces on a plurality of peer machines within a peer-to-peer network comprising:
binding a display object on a first of the plurality of machines to a data source object on the first machine, the display object corresponding to a user interface element, the data source object comprising data usable by the display object for constructing the user interface element;
notifying the display object from the data source object that a change in the data source object has occurred, the change in the data source object being in accordance with a change in the user interface of a second of the plurality of peer machines within the peer-to-peer network;
retrieving information representative of the changed data source object by the display object from the data source object; and
conforming the user interface element to reflect the changed data source object.

11. The computer-readable medium according to claim 10, further comprising instructions for:
receiving over the network from the second of the plurality of peer machines a record having therein data, wherein the data is representative of a user interface element displayed on the second machine; and
creating the change in the data source object by extracting the data from the received record.

12. The computer-readable medium according to claim 11, wherein extracting the data from the received record comprises employing a model of object persistence to create an object from the data of the received record.

13. The computer-readable medium according to claim 10, wherein binding the display object on the first machine to the data source object comprises subscribing by the display object to notification of a change in one or more properties of the data source object.

14. The computer-readable medium according to claim 13, further comprising instructions for providing a notification interface by the display object to receive notification of a change in one or more properties of the data source object, and wherein notifying the display object from the data source object that a change in the data source object has occurred comprises calling of the notification interface by the data source object.

15. The computer-readable medium according to claim 10, wherein users of the plurality of machines are engaged in a group interaction session over the network, wherein each machine manifests a media item to the respective user.

16. The computer-readable medium according to claim 15, wherein the change to the data source object represents a change with respect to the media item.

17. A replicated data store for storing one or more copies of an object residing on a first of a plurality of computers interconnected by a network onto one or more second computers of the plurality of computers comprising:
a peer graph object on the first computer for distributing data representing the object to each of the second computers;
a peer graph object on each of the second computers for receiving the distributed data; and
a data source object on each of the second computers for creating a copy of the object from the data representing the object, wherein the copy of the object is data bound to the data source object.

18. An N to N replicated data store for maintaining a substantially identical copy of an object on each of N peer computers interconnected via a peer-to-peer network comprising:
a peer-to-peer networking module on each of the N interconnected computers for sending information to each of the others of the N interconnected computers, and for receiving information from any of the others of the N interconnected computers;
a data source on each of the N interconnected computers bound to the respective copy of the object on each computer in order that any change in any copy of the object on any of the N interconnected computers is detected by the data source on that computer and is forwarded to the peer-to-peer networking module on that computer, so that notification of the change is forwarded to all others of the N interconnected computers.

19. The N to N replicated data store of claim 18, wherein the peer-to-peer networking module implements the peernet protocol.

20. A method of synchronizing a user interface element for display on each of a plurality of machines interconnected by a peer-to-peer network comprising:
binding a display object on a first of the plurality of machines to a data source object on the first machine, the display object corresponding to the user interface element;
notifying the data source object from the display object that a change in the display object has occurred;
retrieving information representative of the changed display object by the data source object from the display object; and
transmitting the information representative of the changed display object by the data source object to the others of the plurality of peer machines.

21. The method according to claim 20, wherein transmitting the information representative of the changed display object to the others of the plurality of peer machines comprises transferring the information from the data source object to a peer-to-peer connection module on the first of the plurality of peer machines, whereby the information is forwarded to a counterpart peer-to-peer connection module on each of the others of the plurality of peer machines.
